(19) United States
(12) Patent Application Publication
(10) Pub. No.: US 2008/0320406 A1
(43) Pub. Date: Dec. 25, 2008

(54) IMAGE DISPLAYING APPARATUS, IMAGE DISPLAYING METHOD, PROGRAM FOR EXECUTING IMAGE DISPLAYING METHOD, AND STORAGE MEDIUM STORING PROGRAM

(75) Inventors: Shinichi Fukada, Kawasaki-shi (JP); Yoichi Takaragi, Yokohama-shi (JP); Hidetoshi Asasaka, Sagamihara-shi (JP); Rieko Akiba, Tokyo (JP); Toshikazu Sekizawa, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/139,215

(22) Filed: Jun. 13, 2008

(30) Foreign Application Priority Data
Jun. 20, 2007 (JP) 2007-162494

(51) Int. Cl. G06F 3/048

(52) U.S. Cl. 715/766

(57) ABSTRACT

It is controlled to determine priority for each of plural display objects, wherein the priority having plural levels, and to change displays of the plural display objects in the determined priority, in accordance with a display form of an image different from the plural display objects. To achieve this, the present invention provides an image displaying method of displaying the plural display objects on a display unit, the method comprising: determining the priority for each of the plural display objects, and changing the displays of the plural display objects in the determined priority, in accordance with a display form of the image different from the plural display objects.

### BACKGROUND OF THE INVENTION

1. Field of the Invention

The present invention relates to an image displaying apparatus (device) which has a function to display an image, an image displaying method which has a function to display an image, a program which is used to execute the image displaying method, and a storage medium which stores therein the program.

2. Description of the Related Art

Conventionally, there are various kinds of image displaying apparatuses such as a car navigation system, a mobile phone, an MFP (multifunction printer) and the like, each of which has, in addition to an original function, an image display function to display a TV (television) screen, a preview image of an image stored in a memory, and the like.

The image displaying apparatus of this type can display operation keys to be used for originally intended purposes and the images such as the preview screen, the TV screen and the like. Here, it should be noted that, in regard to the preview screen and the TV screen, it is necessary to secure a display area of certain extent so that a user can easily know displayed contents.

In a case where only the preview screen or the TV screen is displayed entirely on the screen of the display unit, that is, in a case where the operation keys to be used for the originally intended purposes are not at all displayed thereon, the user cannot of course operate these operations keys. Further, in a case where the operation keys are displayed so as to overlay the preview screen or the TV screen, the preview screen or the TV screen is partially hidden.

Consequently, in the method disclosed in Japanese Patent Application Laid-Open No. 2003-219308, an object overlapping an image display area is made translucent, or the size of the image display area is made small to acquire a small-sized screen. However, in either case, it is possible to merely reduce interference in viewing of the image display area.

### SUMMARY OF THE INVENTION

The present invention provides an image displaying apparatus and an image displaying method, which overcome the above-described conventional problems.

The present invention aims to provide an image displaying apparatus which displays plural display objects on a display unit, comprising: a determining unit configured to determine priority for each of the plural display objects, the priority having plural levels; and a display control unit configured to change displays of the plural display objects in the priority determined by the determining unit, in accordance with the display form of an image different from the plural display objects.

Further objects and features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate the exemplary embodiments of the present invention and, together with the description, serve to explain the principle of the present invention.

FIG. 1 a block diagram illustrating a constitutional example of a device which has an image display function.

FIG. 2 is a block diagram illustrating an example of a display state of the device which is in a standby state and an example of a display state of the device which is in an image displaying state.

FIG. 3 is a diagram for describing display priority order of objects (buttons or display items) to be displayed on the device.

FIG. 4 is a main flow chart for describing the present invention.

FIG. 5 is a flow chart for describing an example of an operation of the device in case of receiving image data.

FIG. 6 is a flow chart for describing an example of a display operation of the device.

FIG. 7 is a flow chart for describing an example of an object rearrangement operation of the device.

FIG. 8 is a flow chart for describing a device state display operation of the device.

FIG. 9 is a flow chart of a display operation of the device to be executed based on operation history information.

FIG. 10 is a diagram illustrating an example of reduction of an image display area in case of displaying a device state.

FIG. 11 is a diagram illustrating an example of an operation for executing non-display to partial objects in case of displaying the device state.

FIG. 12 is a diagram illustrating an example of an operation for executing display in case of adding a new function.

FIG. 13 is a diagram illustrating an example of displaying the image display area and the device state in parallel.

FIG. 14 is a diagram illustrating an example of displaying device operation buttons and operation buttons for an input image.

FIG. 15 is a diagram illustrating an example of executing priority display of the operation buttons according to attributes.

### DESCRIPTION OF THE EMBODIMENTS

Hereinafter, the exemplary embodiments of the present invention will be described.

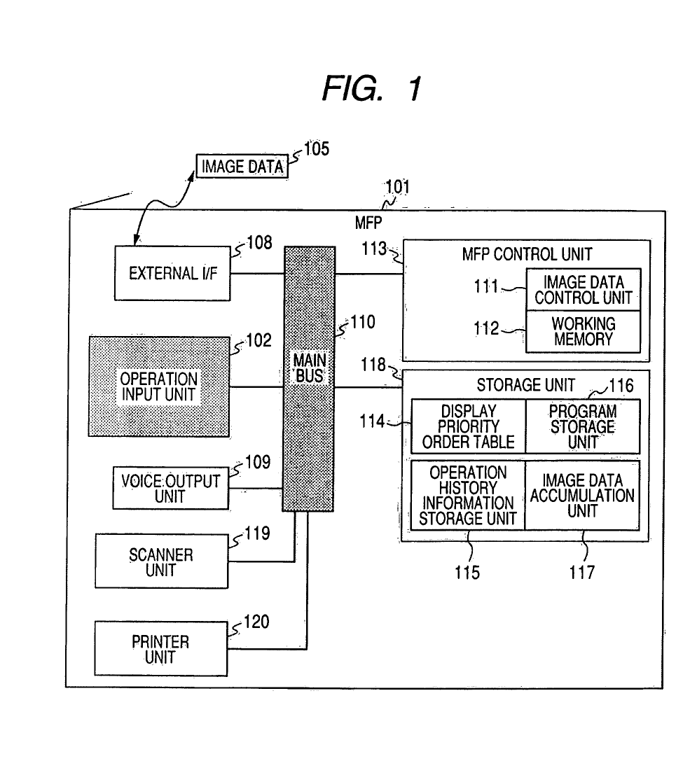

FIG. 1 a block diagram illustrating a constitutional example of a device which has an image display function. In the following, although an MFP (multifunction printer) having a copy function and a print function will be described as an example of the concrete device, the present invention is not limited to this. Namely, the present invention may be applied also to a printer device having a single function, a scanner device, a data transmission/reception device such as a facsimile device, a mobile phone terminal, a video data display device and the like. In any case, FIG. 1 will be described in order of reference numerals.

In the present embodiment, the main body of a device 101 is the MFP as described above.

The device (or the MFP) 101 includes an operation input unit 102.

Image data 105 is input to the device 101 through an external I/F (interface) 108. Here, the image data 105 in this case indicates a still image, a moving image and/or a TV (television) picture. Namely, the kind of image to be indicated by the image data 105 is not limited to specific kind of data.

The external I/F 108 is used to execute communication between the device 101 and an external device, as described above. Here, it should be noted that both a wireless interface and a wired interface can be used as the external I/F 108. More specifically, the external I/F 108 is the interface which is used to transmit/receive various data including an operation instruction, device status information and an image data to/from the external device. Further, it should be noted that the external I/F 108 may include a function as a media slot or the like of the device 101 to accept input image data and the like.

A voice output unit 109 outputs, by means of voice, audio or the like, the explanation of the functions of the device 101, the usage and the state of the device 101, the voice information included in the transmitted/received image data, and the like. More specifically, the voice output unit 109 is constituted by a speaker, a known voice codec or the like.

A main bus 110 is the data communication paths to be used to transmit/receive various data in the device 101.

An image data control unit 111 detects pixel information, forms and the like of the image data received by the device 101, and controls a display of the received image data (for example, decoding of the received moving image, the received TV image and the like). More specifically, the image data control unit 111 includes an image analysis module, a moving image decode module, a TV image tuner and the like.

A working memory 112 is used when the image data control unit 111 extracts the image data and executes various processes to the extracted image data. More specifically, the working memory 112 is constituted by a RAM (random access memory).

An MFP control unit 113 controls the whole of the device 101. More specifically, the MFP control unit 113 includes a CPU (central processing unit), the image data control unit 111 and the working memory 112.

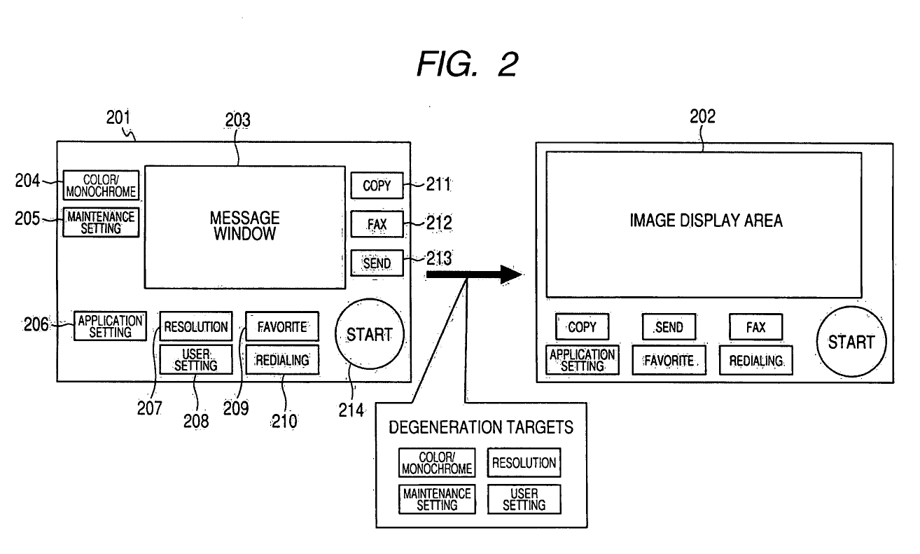

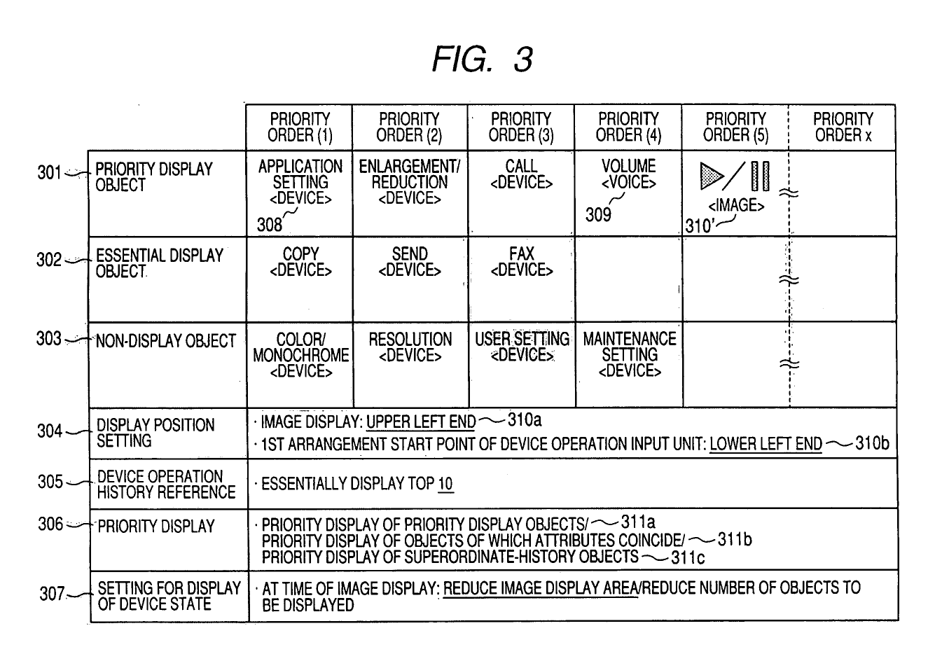

A display priority order table 114 indicates display priority order (priority) held in the device 101. More specifically, the display priority order of the objects such as various buttons, display items and the like to be used when the received image data is displayed on an image display area 202 (FIG. 2) of the operation input unit 102 has been held on the display priority order table 114. Namely, the display priority order indicating whether or not to display each of the display objects has been held on the display priority order table 114. In any case, the detail of the display priority order table 114 will be described later with reference to FIG. 3.

An operation history information storage unit 115 stores therein a history of operation inputs input through the operation input unit 102 and a reception history of instruction information received through the external I/F 108.

A program storage unit 116 stores therein programs to be executed by the MFP control unit 113.

An image data accumulation unit 117 accumulates image data input through the external I/F 108, image data input from a scanner unit 119, and image data output to a printer unit 120.

A storage unit 118 is constituted by the display priority order table 114, the operation history information storage unit 115, the program storage unit 116 and the image data accumulation unit 117. More specifically, the storage unit 118 is constituted by a hard disk.

Although the storage unit 118 is constituted by the hard disk in the present embodiment, the present invention is not limited to this. Namely, the storage unit 118 may be constituted by a semiconductor memory such as a ROM (read only memory), a flash memory or the like, a detachable memory such as a USB (Universal Serial Bus) memory or the like, a combination of the semiconductor memory and the hard disk, or the like.

The scanner unit 119 reads an original, and the printer unit 120 prints image data.

Subsequently, FIG. 2 will be described hereinafter. FIG. 2 illustrates a typical embodiment which is assumable in the present invention.

In FIG. 2, an operation screen 201, which is displayed on the operation input unit 102, is constituted by a touch panel liquid crystal display which displays plural display objects. More specifically, the MFP control unit 113 causes the operation input unit 102 to display the operation screen 201 for displaying various kinds of objects indicating the states of the device, whereby the user can operate the displayed buttons and confirm the various displayed items. Although the operation screen 201 is constituted by the touch panel liquid crystal display in the present embodiment, the present invention is not limited to this. Namely, a liquid crystal display having no touch panel, a CRT (cathode ray tube) display or the like may be used for the operation screen 201. In such a case, a pointing device such as a mouse or the like is used to indicate the displayed objects. Besides, the image display area 202 is produced when image data is input to the device 101.

A message display section (or a message window) 203 is used to display various messages on the operation screen 201. More specifically, the message display section 203 is used to display an operation state of the device 101, paper setting information, various setting information and the like.

A button 204 is used to select whether the original should be read as a color image or a monochrome image by the scanner unit 119. A button 205 is used to set a mode for a service person or the user of the device 101 to execute maintenance. A button 206 is used to set a double-sided copy mode, a stapling mode, a bookbinding mode, a reduction layout mode and the like. A button 207 is used to designate resolution at a time when the original is read by the scanner unit 119. A button 208 is used to execute various settings by the user. A button 209 is used to register the functions which are frequently used by the user. A button 210 is used to execute redialing to a telephone line. A copy key (or a copy button) 211 is used to set the operation mode of the device 101 to a copy mode. In the copy mode, the device 101 can execute various settings concerning the copy function. A fax button 212 is used to set the operation mode of the device 101 to a fax mode. In the fax mode, the device 101 can execute various settings concerning a facsimile function. A send button 213 is used to set the operation mode of the device 101 to a send mode. In the send mode, the device 101 can execute various settings to transmit the image data read by the scanner unit 119 or the image data stored in the image data accumulation unit 117 to a predetermined destination. A start key 214 is used to instruct reading of the original. Further, the operation screen 201 includes a playback button, a fast forward button, a rewind button and the like (all not illustrated) to be used for reproducing video data. Furthermore, the operation screen 201 includes a channel button to be used for viewing TV programs, a volume button to be used for adjusting sound volume, and the like (all not illustrated). Although the buttons for indicating various operations are described in the present embodiment, the present invention is not limited to them. That is, display items respectively indicating date information, hour information, time information, a device state and the like may be displayed as objects on the operation screen 201.

The device 101 receives the image data 105, and then causes the operation input unit 102 to display the received image data 105 based on the vertical and horizontal sizes thereof. Here, the thin arrow in FIG. 2 indicates that the state that the message display section 203 is being displayed changes to the state that the image display area 202 is displayed. More specifically, in case of actually producing the image display area 202, the MFP control unit 113 executes non-display for the display objects indicating several buttons on the operation input unit 102 to secure the image display area 202. It should be noted that this operation is called “degeneration”. Thus, the display objects indicating several buttons are not displayed (in non-display). However, even in a case where the received image data is being displayed, the display objects indicating the copy button 211, the fax button 212, the send button 213 and the like are still displayed. Thus, even if a certain user is viewing the received image/moving image, handling of the image data is not disturbed. Moreover, even in this case, it brings about a significant effect that another user can use the device functions based on the copy mode, the fax mode and the send mode. In addition, since non-display is executed to the buttons (or the items) which are not so used, it also brings about a significant effect that the area for displaying the received image data is made larger.

FIG. 3 is a diagram illustrating an example of the display priority order table 114 which indicates the display priority order of the objects (the buttons or the display items) to be displayed when the image data is displayed on the operation input unit 102.

<301: Priority Display Objects (Buttons or Display Items)>

The section 301 indicates the priority order of the respective objects (the buttons or the display items) on the operation input unit 101 in the case where the MFP control unit 113 produces the image display area 202. In the present embodiment, the item of which the priority order is lower is preferentially set to be in a non-display state. That is, as the priority order is lower, it is more difficult to be the target of non-display. Consequently, in the present embodiment, the higher priority order is set to the function which is frequently used (for example, an application setting function button). Thus, even if the received image is being displayed, the function which is frequently used is available for the user. Each of the registered objects (the buttons or the display items) includes the object and the attribute, the object is made by characters/images actually displayed on the operation unit, and the attribute indicates the target on which the object acts. Incidentally, an item 308 indicates that the target on which the object acts is the device, an item 309 indicates that the target on which the object acts is the voice data, and an item 310′ indicates that the target on which the object acts is the image data such as video data or the like. In FIG. 3, for example, the display items registered for the priority order (1) include “application setting” as the body of the item and “device” as the attribute.

<302: Essential Display Objects (Buttons or Display Items)>

The section 302 indicates the objects (the buttons or the display items) which are essentially displayed simultaneously and concurrently with the image display area 202 when the image display area 202 is produced by the operation unit.

<303: Non-Display Objects (Buttons or Display Items)>

The section 303 indicates the objects (the buttons or the display items) which are non-displayed on the operation input unit 102 when the image display area 202 is produced on the operation input unit 102.

<304: Display Position Setting>

The section 304 is used to set the display positions of the objects such as the buttons (or the items) on the operation input unit 102.

<310a: image Display>

The section 310a is used to set which position on the operation input unit 102 the objects should be arranged. In the present embodiment, “upper left end” is set, and this implies that the image display area 202 is arranged so as to be in contact with the upper left end of the operation input unit 102.

<310b: Object (Button or Display Item) display start point>

The section 310b is used to set, when the objects (the buttons or the display items) are rearranged, the position from which display of the rearranged objects (the buttons or the display items) starts.

<305: Device Operation History Reference>

The section 305 indicates that, when the image display area 202 is produced on the operation input unit 102, the history information accumulated and stored in the operation history information storage unit 115 is referred. The MFP control unit 113 determines the objects (the buttons or the display items) which should be displayed or non-displayed, based on the history information. In the present embodiment, the value “10” is set to the section 305 so as to essentially display higher 10 objects which are frequently used from the stored history information.

<306: Priority Display>

The section 306 indicates the setting for determining the standard to select the objects (the buttons or the display items) to be displayed when the objects (the buttons or the display items) are rearranged according to producing of the image display area 202 on the operation input unit 102.

In the present embodiment, after the essential display objects (the buttons or the display items) were set, it is selectively set which object should be displayed. More specifically, it is selectively set which of the objects, that is, a setting 311a for displaying the priority display objects, a setting 311b for displaying the objects of which the attributes coincide, and a setting 311c for displaying the higher-order objects in the history. In any case, the concrete meaning of each of the settings is as follows.

<311a: Priority Display>

The operation unit rearranges the display objects (the buttons or the display items) by referring to the priority display objects 301.

<311b: Attribute Priority>

The operation unit preferentially displays the objects of which the attributes coincide with those of the higher-priority display objects 301 and 302, by referring to the attributes of the respective objects (the buttons or the display items). Here, the priority order in the same attribute is determined by referring to the priority order of the priority display object (the button or the display item) 301.

More specifically, the objects are displayed in order of the essential display object (the button or the display item) and the priority display object (the button or the display item).

<311c: History Priority>

The operation unit preferentially displays the higher-order objects of the history information.

For example, the operation unit rearranges the objects (the buttons or the display items) to be displayed, based on the history of operation numbers of each button (or each item).

<307: Setting for Displaying Device State>

The section 307 defines, in the state that the image display area 202 has been produced, the operation to be executed in a case where the window indicating device states is displayed on the operation input unit 102. More specifically, in the section 307, it is set how the window area indicating the device state should be secured in relation to the image display area 202.

In the present embodiment, the image display area 202 is reduced in size, or several objects (the buttons or the display items) displayed on the operation input unit 102 are further non-displayed. It is hereby possible to secure the window area indicating the device state.

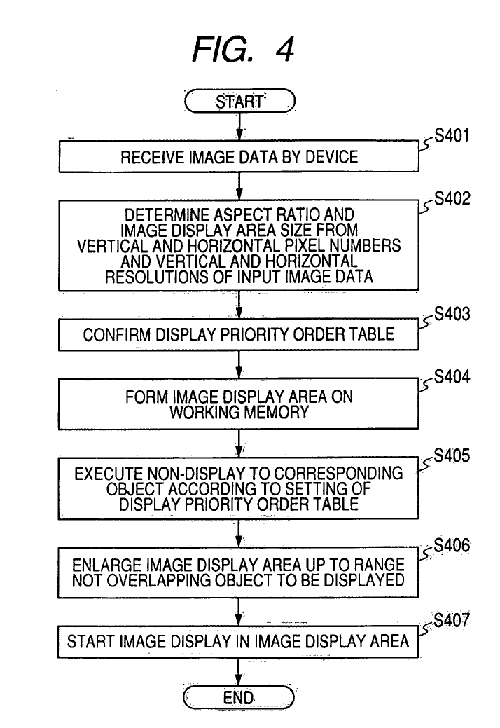

FIG. 4 is a main flow chart for describing the present invention. It should be noted that this main flow chart has been stored in the program storage unit 116 in the form of the program. The MFP control unit 113 executes the process of the flow chart illustrated in FIG. 4 according to the program stored in the program storage unit 116. Hereinafter, the operation of the MFP control unit 113 will be described with reference to FIG. 4.

In S401, the device 101 receives the image data 105 through the external I/F 108. Then, if the image data 105 is received, the MFP control unit 113 advances the process to S402. In S402, the image data control unit 111 calculates an aspect ratio based on vertical and horizontal resolutions and vertical and horizontal pixel numbers of the image data input to the device 101, thereby determining the size of the image display area 202.

Consequently, the image data control unit 111 constituting the MFP control unit 113 functions as an image display area determination unit.

In S403, the MFP control unit 113 confirms the setting in the case where the device 101 receives the image data. More specifically, the MFP control unit 113 confirms the display priority order table 114 already described with reference to FIG. 3. Besides, it is possible for the MFP control unit 113 to confirm another device display setting other than the display priority order table 114 indicating the display priority order.

Consequently, the MFP control unit 113 refers to the display priority order table 114 and operates according to the program stored in the program storage unit 116. As a result, the MFP control unit 113 functions as a display priority order determination unit.

In S404, the MFP control unit 113 produces the image display area 202. More specifically, the MFP control unit 113 produces the image display area 202 on the working memory 112 based on the size of the image display area 202 calculated in S402 and the setting value of the section 310a confirmed in S403.

In S405, the MFP control unit 113 executes non-display to the relevant objects (the buttons or the display items) in the operation input unit 102 according to the image display area 202 produced in S404 and the display setting confirmed in S403.

In S406, the MFP control unit 113 enlarges the image display area 202 within a range not overlapping variously displayed objects (the buttons or the display items), and rearranges the objects (the buttons or the display items) to be displayed. At this time, the MFP control unit 113 does not change the aspect ratio of the image display area 202. Consequently, even in case of changing a magnification, it brings a significant advantage that it is possible to view a lower-distortion image. Incidentally, the image display area 202 is enlarged in the present embodiment, it is also possible to execute a same size process or a reduction process if the size of an image (data) to be displayed is large. Consequently, it brings a significant advantage that the image display area 202 can secure the area which is larger than the area of the message display section 203 for executing various device settings and state confirmation. Moreover, it brings a significant advantage that the objects (the operation buttons or the display objects) can be arranged at respective positions suitable for a horizontally long image such as an HDTV (High Definition Television) image of which the aspect ratio is 16:9.

As just described, the MFP control unit 113 refers to the display priority order table 114 and operates according to the program stored in the program storage unit 116. As a result, the MFP control unit 113 functions as an arrangement unit.

In S407, the MFP control unit 113 displays the input image data 105 in the image display area 202 enlarged in S406.

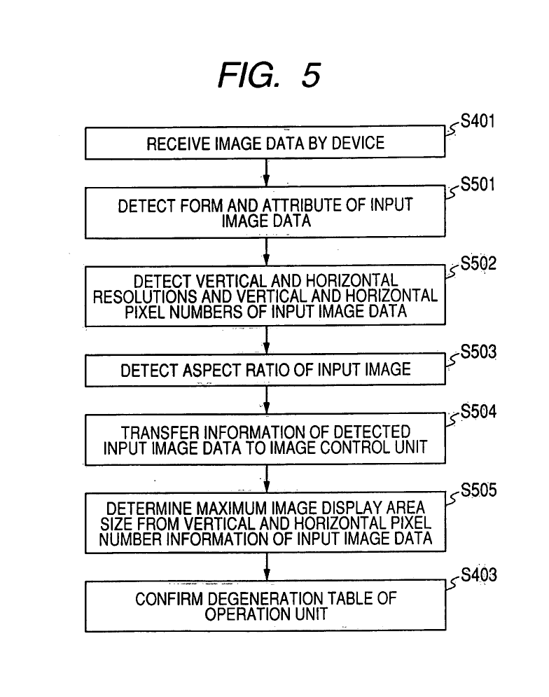

Incidentally, although the MFP control unit 113 executes the process of the flow chart illustrated in FIG. 4 according to the program stored in the program storage unit 116 in the present embodiment, the present invention is not limited to this. That is, the operation input unit 102 may include a processor and a program storage unit and thus execute the process of the flow chart illustrated in FIG. 4. FIG. 5 is a flow chart for describing an example of an operation in a case where the device receives the image data. Here, it should be noted that the process of the flow chart illustrated in FIG. 5 corresponds to the detail of the process in S402 of FIG. 4. The program for executing the process of the flow chart illustrated in FIG. 5 has been stored in the program storage unit 116. The MFP control unit 113 executes the process of the flow chart illustrated in FIG. 5 according to the program stored in the program storage unit 116. Hereinafter, the operation of the MFP control unit 113 will be described with reference to FIG. 5.

The process in S401 is substantially the same as that in S401 illustrated in FIG. 4.

In S501, the MFP control unit 113 causes the image data control unit 111 to detect the form of the image data received by the device 101. More specifically, it is first determined whether the received image data indicates a still image or a moving image, and then the size of the image data, the form of the image data such as a decoding form or the like, the attribute, and the like are detected.

In S502, the MFP control unit 113 causes the image data control unit 111 to detect the vertical and horizontal resolutions and the vertical and horizontal pixel numbers of the input image data 105.

In S503, the MFP control unit 113 causes the image data control unit 111 to detect the aspect ratio of the input image data 105 based on the vertical and horizontal resolutions and the vertical and horizontal pixel numbers detected in S502.

In S504, the MFP control unit 113 stores, in the working memory 112, the results detected by the image data control unit 111 in S501 to S503.

In S505, the MFP control unit 113 causes the image data control unit 111 to acquire, from the contents of the input image data stored in the working memory 112, the maximum size of the image display area 202 to be produced on the operation unit. The reason why the maximum size of the image display area 202 should be determined is that, if the image display area 202 of which the pixel number is larger than that of the input image data 105 is produced, it is necessary to execute pixel interpolation to the input image data 105, whereby image quality in case of actually displaying the input image data deteriorates.

The process in S403 is substantially the same as that in S403 illustrated in FIG. 4.

Incidentally, although the MFP control unit 113 executes the process of the flow chart illustrated in FIG. 5 according to the program stored in the program storage unit 116 in the present embodiment, the present invention is not limited to this. That is, the image data control unit 111 may execute the above process, instead of the MFP control unit 113. Besides, the operation input unit 102 may include a processor, a program storage unit, an image data control unit and the like, and thus execute the above process.

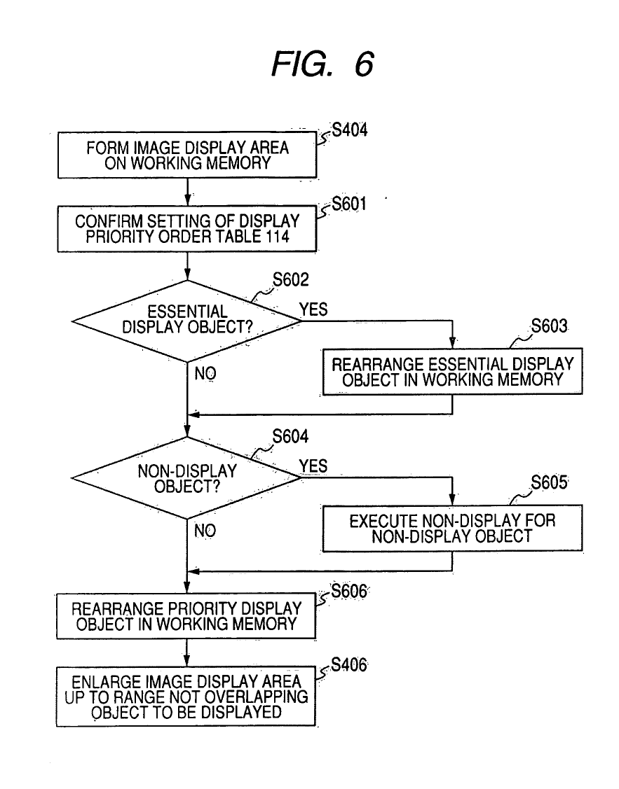

FIG. 6 is a flow chart for describing an example of a display operation of the operation input unit 102. Here, it should be noted that the process of the flow chart illustrated in FIG. 6 corresponds to the detail of the process in S405 of FIG. 4. The program for executing the process of the flow chart illustrated in FIG. 6 has been stored in the program storage unit 116, and the MFP control unit 113 executes the process of the flow chart illustrated in FIG. 6 according to the program stored in the program storage unit 116. Hereinafter, the operation of the MFP control unit 113 will be described with reference to FIG. 6.

The process in S404 is substantially the same as that in S404 illustrated in FIG. 4.

In S601, the MFP control unit 113 confirms the setting of the display priority order table 114 illustrated in FIG. 3. More specifically, the information such as the priority display objects (301), the essential display objects (302), the non-display objects (303), the display position settings (304), the device operation history information (305), the priority display settings (306), the device state display settings (307), and the like are confirmed by the MFP control unit 113.

In S602, the MFP control unit 113 confirms the essential display objects (the buttons or the display items) on the display priority order table 114.

In S603, the MFP control unit 113 executes control if it is determined in S602 that the setting of the essential display object (the button or the display item) exists. More specifically, in this case, the MFP control unit 113 rearranges, in the working memory 112, the essential display objects (the buttons or the display items) registered on the display priority order table 114.

In S604, the MFP control unit 113 confirms whether or not the setting of the non-display objects (the buttons or the display items) exists on the display priority order table 114.

In S605, the MFP control unit 113 executes control if it is determined in S604 that the setting of the non-display object (the button or the display item) exists. More specifically, in this case, the MFP control unit 113 executes, in the operation input unit 102, non-display of the non-display objects (the buttons or the display items) registered on the display priority order table 114.

In S606, the MFP control unit 113 rearranges, in the operation unit, the objects (the buttons or the display items) registered for the priority display objects (the buttons or the display items) on the display priority order table 114.

More specifically, the relevant objects are rearranged on the position which does not overlap a virtual area on the working memory as the image display area 202. Namely, such a virtual image display area (202) is used to secure the image display area 202, and this virtual area is used to confirm whether or not the image display area 202 can be produced.

The process in S406 is substantially the same as that in S406 illustrated in FIG. 4.

In the present embodiment, the MFP control unit 113 selects display or non-display of the objects according to the settings set in the sections 301, 302 and 303 on the display priority order table 114. However, the present invention is not limited to this. That is, the MFP control unit 113 may select display/non-display of the respective objects based on the device operation history information (305), the priority display settings (306), the device state display settings (307) and the like.

Here, the MFP control unit 113 executes the process of the flow chart illustrated in FIG. 6 according to the program stored in the program storage unit 116. However, the present invention is not limited to this. Namely, the operation input unit 102 may include a processor, a program storage unit and the like, and thus execute the above process.

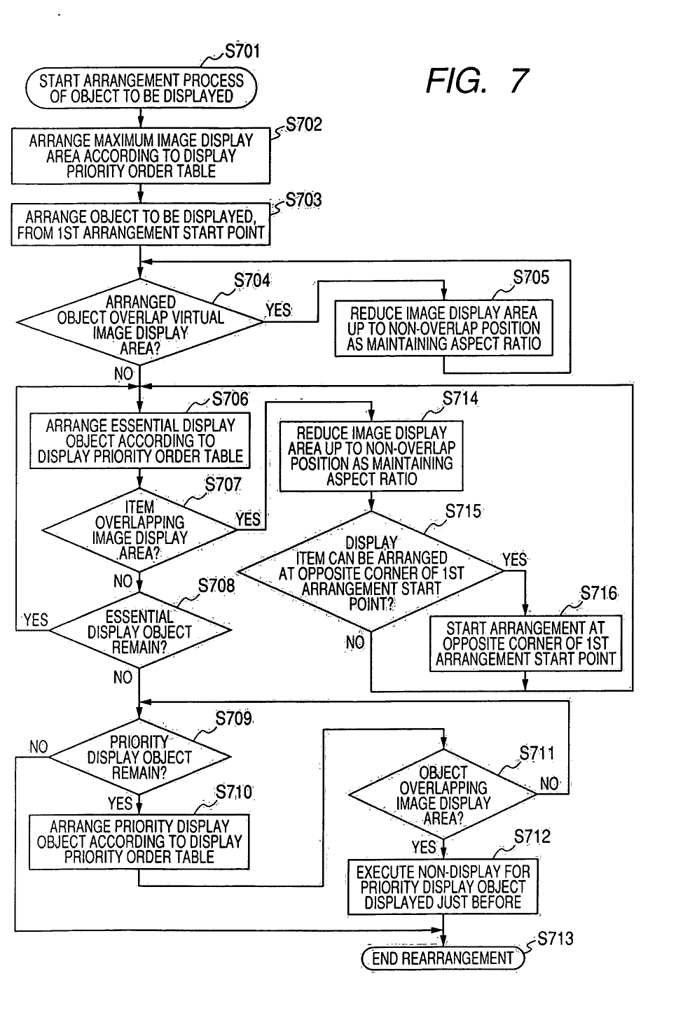

FIG. 7 is a flow chart for describing an example of a rearrangement operation of each of the various objects (the buttons or the display items) according to the present invention. Here, it should be noted that the MFP control unit 113 executes the process of the flow chart illustrated in FIG. 7 according to the program stored in the program storage unit 116. Hereinafter, the operation of the MFP control unit 113 will be described with reference to FIG. 6. Incidentally, it should be noted that the process of the flow chart illustrated in FIG. 7 corresponds to the detail of the processes in S603 to S606 of FIG. 6.

In S701, the MFP control unit 113 starts to execute an arrangement process for the objects (the buttons or the display items) on the operation screen 201 to produce the image display area 202.

In S702, the MFP control unit 113 arranges the maximum virtual image display area (202) according to the display priority order table 114.

In S703, the MFP control unit 113 arranges one of the essential display objects (the buttons or the display items) registered on the display priority order table 114, based on the first arrangement start point (the object display start point 310b) set on the display priority order table 114.

In S704, the MFP control unit 113 determines whether or not the already arranged essential display object (the button or the display item) overlaps the virtual image display area (202).

In S705, if it is determined in S704 that the essential display object (the button or the display item) overlaps the virtual image display area (202), the MFP control unit 113 reduces the relevant virtual image display area (202) to the size by which the essential display object does not overlap the virtual image display area, as maintaining the aspect ratio of the virtual image display area (202).

In S706, the MFP control unit 113 arranges, within the range of the operation screen 201, the object not yet arranged from among the essential display objects (the buttons or the display items) on the display priority order table 114.

In S707, the MFP control unit 113 determines whether or not the already arranged essential display object (the button or the display item) overlaps the virtual image display area (202).

In S708, the MFP control unit 113 confirms whether or not the object (the button or the display item) not yet arranged exists in the essential display objects (the buttons or the display items) on the display priority order table 114. In other words, it is confirmed whether or not the essential display object remains.

In S709, if it is confirmed in S708 that the object (the button or the display item) not yet arranged does not exist in the essential display objects (the buttons or the display items), the MFP control unit 113 confirms that the priority display object (the button or the display item) not yet arranged exists in the priority display objects (the buttons or the display items) on the display priority order table 114. In other words, it is confirmed whether or not the priority display object remains.

In S710, if it is confirmed in S709 that the object (the button or the display item) not yet arranged exists in the priority display objects (the buttons or the display items), the MFP control unit 113 arranges the objects (the buttons or the display items) remaining in the priority display objects (the buttons or the display items) on the display priority order table 114.

In S711, the MFP control unit 113 determines whether or not the already arranged priority display object (the button or the display item) overlaps the virtual image display area (202).

In S712, if it is determined in S711 that the priority display object (the button or the display item) arranged just before overlaps the virtual image display area (202), the MFP control unit 113 non-displays the priority display object (the button or the display item) arranged just before the determination in S711 and overlapping the virtual image display area (202).

In S713, the MFP control unit 113 ends the rearrangement process.

In S714, if it is determined in S707 that the essential display object (the button or the display item) rearranged by the MFP control unit 113 overlaps the virtual image display area (202), the MFP control unit 113 reduces the relevant virtual image display area (202) to the size by which the essential display object does not overlap, as maintaining the aspect ratio of the virtual image display area (202).

In S715, if the image display area 202 is reduced in S714, the MFP control unit 113 confirms whether or not the essential display object (the button or the display item) can be arranged at the position, on the operation unit, which is diagonal in regard to the first arrangement start point set on the display priority order table 114.

In S716, if it is confirmed in S715 that the essential display object (the button or the display item) can be arranged, the MFP control unit 113 arranges the object (the button or the display item) also at the position, on the operation unit, which is diagonal in regard to the first arrangement start point.

If the essential display object overlaps the image display area 202, the image display area is reduced. Thus, it brings a significant advantage that the user can operate the device without preventing image viewing.

On the other hand, if the priority display object overlaps the image display area 202, the non-display is executed to the necessary objects. Thus, it brings a significant advantage that the user can view the image without problems even if the image display area is not excessively reduced.

In the present embodiment, the non-display is executed to the priority display object if it overlaps the image display area 202. However, the present invention is not limited to this. That is, the image display area 202 may be reduced within the range that the viewing of the image displayed in the image display area 202 does not become difficult.

In the present embodiment, the MFP control unit 113 executes the process of the flow chart illustrated in FIG. 7 according to the program stored in the program storage unit 116. However, the present invention is not limited to this. Namely, the operation input unit 102 may include a processor, a program storage unit and the like, and thus execute the above process.

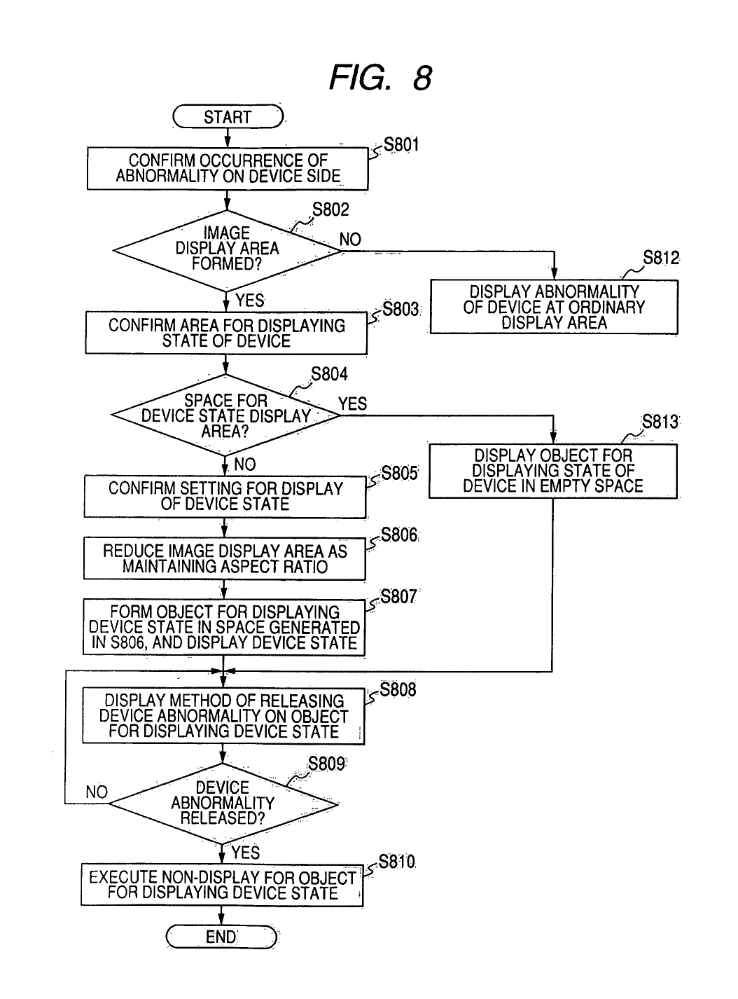

FIG. 8 is a flow chart for describing a device state display operation of the device.

In the present embodiment, the example that the MFP control unit 113 executes the process of the flow chart illustrated in FIG. 8 according to the program stored in the program storage unit 116 will be described.

In S801, it is confirmed that abnormality occurs in the body of the MFP (or the device) 101. The present embodiment assumes, as the abnormality, a paper jam, out of toner, out of ink, and the like in the MFP 101. If it is confirmed that the abnormality occurs in the MFP 101, then the MFP control unit 113 determines in S802 whether or not the image display area 202 is currently produced.

If it is determined in S802 that the image display area 202 is not produced, the MFP control unit 113 advances the process to S812.

In S812, the abnormality of the device is displayed on the ordinary display area (the message window 203).

On the other hand, if it is determined in S802 that the image display area 202 is currently produced, the MFP control unit 113 advances the process to S803.

In S803, the MFP control unit 113 confirms the display size of the area for displaying the state of the device.

In S804, the MFP control unit 113 confirms whether or not the area for displaying the state of the device can be secured within the current operation screen.

If it is confirmed in S804 that the area for displaying the state of the device has been secured, then the object for displaying the state of the device is displayed in an empty space in S813. Then, the MFP control unit 113 advances the process to S808.

In S805, if it is confirmed in S804 that there is no display space in the area for displaying the state of the device, then the setting (307) concerning the display of the state of the device on the display priority order table 114 is confirmed. In the present embodiment illustrated in FIG. 2, it is assumed that reduction of the image display area 202 is set.

In S806, in response to the confirmation result of S805, it reduces the image display area 202 as maintaining the aspect ratio thereof, thereby securing the area for displaying the state of the device.

In S807, the MFP control unit 113 produces the object (the area) for displaying the state of the device on the space of the operation screen 201, thereby displaying the state of the device.

In S808, the MFP control unit 113 also displays a method for releasing the abnormality of the device, in the object (the area) for displaying the state of the device.

In S809, the MFP control unit 113 periodically confirms whether or not the abnormality of the device is released.

In S810, if it is confirmed in S809 that the abnormality of the device is released, the MFP control unit 113 non-displays the object for displaying the state of the device. That is, non-display is executed to the object for displaying the state of the device. In this case, the MFP control unit 113 non-displays the area for displaying the state of the device and also returns the display state to that of the operation unit layout at the time of S801.

Here, if it is confirmed in S804 that there is no area for displaying the state of the device, the image display area is reduced in the present invention. However, the present invention is not limited to this. That is, in the setting (307) concerning the display of the state of the device, if it is set to reduce the number of objects to be displayed, it is possible to reduce the number of objects to be displayed instead of reducing the image display area.

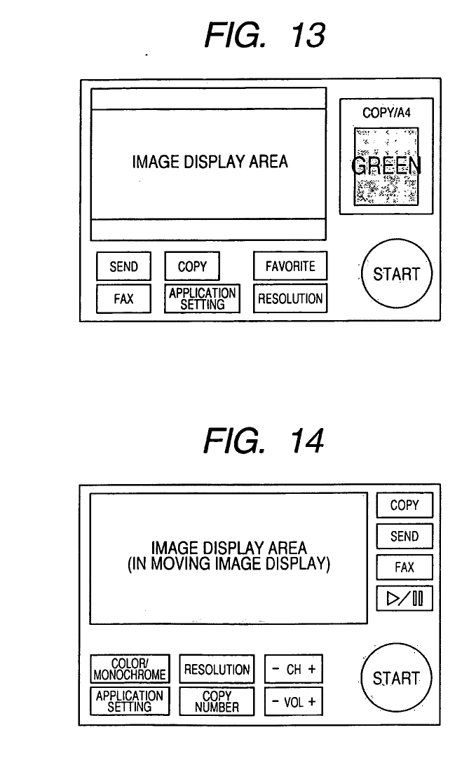

Further, in the present embodiment, the object for displaying the state of the device is non-displayed if the abnormality of the device is released. However, the present invention is not limited to this. That is, as illustrated in FIG. 13, the object for displaying the state of the device may continuously be displayed even after the abnormality of the device is released.

Furthermore, in the present embodiment, the MFP control unit 113 executes the process of the flow chart illustrated in FIG. 8 according to the program stored in the program storage unit 116. However, the present invention is not limited to this. Namely, the operation input unit 102 may include a processor, a program storage unit and the like, and thus execute the above process.

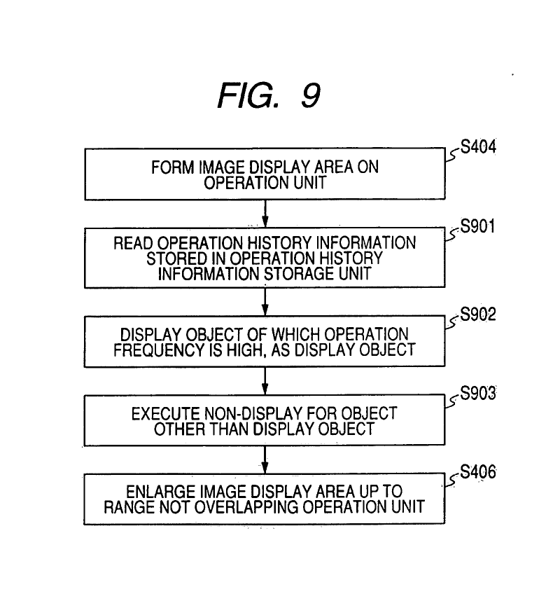

FIG. 9 is a flow chart of a display operation of the device to be executed based on operation history information. In the present embodiment, the process of the flow chart in FIG. 9 corresponds to another embodiment (modification) of the process in S405 illustrated in FIG. 4. In the following, the process of the flow chart in FIG. 9 will be described.

Here, the example that the MFP control unit 113 executes the process of the flow chart illustrated in FIG. 9 according to the program stored in the program storage unit 116 will be described.

The process in S404 is substantially the same as that in S404 illustrated in FIG. 4.

In S901, the MFP control unit 113 confirms the setting of the device operation history information (305) on the display priority order table 114. If the setting of the device operation history information (305) is confirmed, the MFP control unit 113 reads the operation history information stored in the operation history information storage unit 115.

In S902, if the operation history information of the device is confirmed in S901, the MFP control unit 113 sets the upper “n” order objects, of which the operation frequencies are high in the operation history information, as the essential display objects (the buttons or the display items). Further, the MFP control unit 113 classifies the objects subsequent to the upper “n” order objects to the priority display items. Here, it should be noted that “n” may previously be stored in the storage unit 118 or may arbitrarily be set by the user.

In S903, the MFP control unit 113 executes non-display of the objects not selected as the display objects in S902. More specifically, the process same as that illustrated in FIG. 7 is executed.

The process in S406 is substantially the same as that in S406 illustrated in FIG. 4.

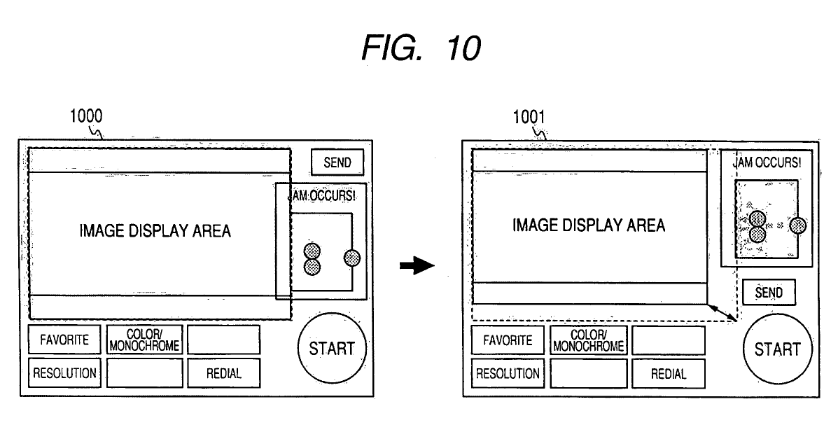

In the present embodiment, the MFP control unit 113 executes the process of the flow chart illustrated in FIG. 8 according to the program stored in the program storage unit 116. However, the present invention is not limited to this. Namely, the operation input unit 102 may include a processor, a program storage unit and the like, and thus execute the above process. FIG. 10 is a diagram illustrating an example of reduction of the image display area 202 in case of displaying the device state. Here, it should be noted that the operation of this example corresponds to the process described with reference to FIG. 8.

In FIG. 10, a state 1000 conceptually indicates that it is confirmed whether or not the area for displaying the object (for example, an object displayed as “jam occurs!”) to display the state of the device exists on the operation input unit 102. Here, the MFP control unit 113 confirms whether or not to be able to secure the space for displaying the object to display the state of the device. In the present embodiment, it can be understood that the image display area 202 partially overlaps the area for displaying the state of the device. As a result, the MFP control unit 113 confirms that the space of the area for displaying the state of the device is insufficient.

Then, a state 1001 indicates that the area for displaying the state of the device can be secured by reducing the image display area 202.

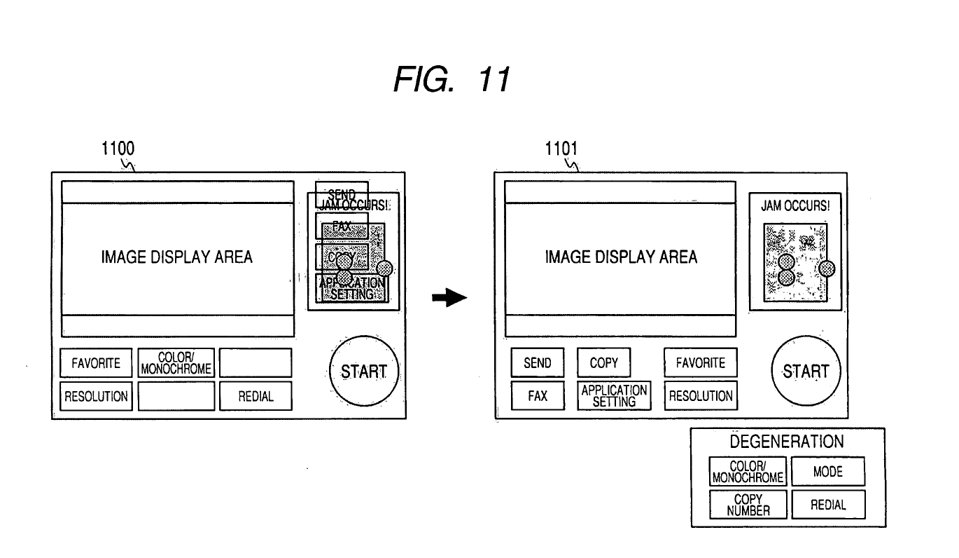

FIG. 11 is a diagram illustrating an example of an operation for executing non-display to partial objects in case of displaying the state of the device. Here, it should be noted that the operation of this example corresponds to the process described with reference to FIG. 8.

As well as the state 1000 illustrated in FIG. 10, a state 1100 conceptually indicates that it is confirmed whether or not the area for displaying the object (for example, an object displayed as “jam occurs!”) to display the state of the device exists on the operation input unit 102. In other words, the state 1100 indicates that the MFP control unit 113 confirms whether or not to be able to secure the space for displaying the object to display the state of the device. In the present embodiment, it can be understood that the operation buttons (“SEND”, “FAX”, “COPY” and “APPLICATION SETTING” buttons) partially overlap the area for displaying the state of the device. As a result, the MFP control unit 113 confirms that the area for displaying the state of the device is insufficient.

Then, a state 1101 indicates that the area for displaying the state of the device can be secured by executing non-display of the objects (the operation buttons or the display items).

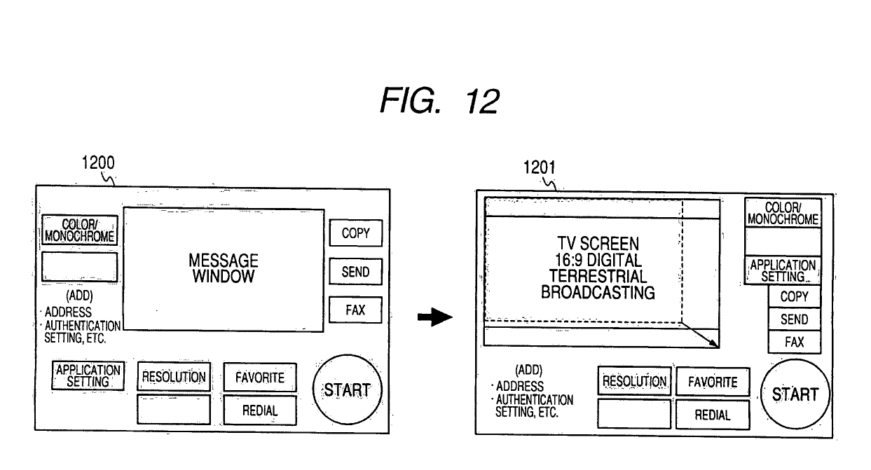

FIG. 12 is a diagram illustrating an example of, in a case where new objects are added to the operation input unit, rearranging the objects by installing a new function program to the device.

In FIG. 12, a state 1200 indicates that the MFP control unit 113 displays on the operation input unit 102 the display object (an IC card function) concerning the function newly added to the device. In the present embodiment, since the image display area 202 of the operation input unit 102 overlaps the display object concerning the newly added function, the display object concerning the newly added function is semitransparently displayed.

Then, a state 1201 indicates that the MFP control unit 113 enlarges the image display area and rearranges the objects so as to display the object concerning the newly added function.

In the present embodiment, the MFP control unit 113 executes the operation according to the program stored in the program storage unit 116.

If a new function program (for example, an ID card application) is installed to the device, the MFP control unit 113 updates the contents of the display priority order table 114. Thus, the object indicating the ID card application is registered as the essential display object. Then, if the object indicating the ID card application is registered as the essential display object, the MFP control unit 113 executes arrangement of the respective objects and/or enlargement or reduction of the image display area, on the basis of the relation of the respective objects and the relation of the image display area (FIGS. 6, 7 and 8).

Further, the processes in S801 to S807 of FIG. 8 may be replaced with the following processes. More specifically, “confirm occurrence of abnormality on device side” in S801 may be replaced with “confirm new function program (for example, ID card application) installed in device”. Further, the processes for “the area for displaying the device state” in S802 to S807 may be replaced with the processes for “the object indicating the new function program (for example, ID card application)”. In this case, the processes of S808 to S811 are not actually executed because these processes are not relative to the installation of the new function program.

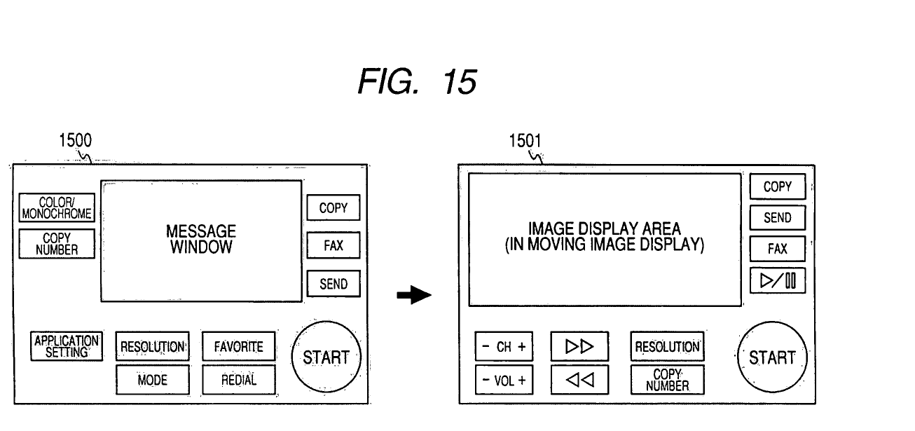

FIG. 13 is a diagram illustrating an example of displaying the image display area 202 and the device state in parallel. More specifically, FIG. 13 indicates that the display state of the device is set to be maintained even after the device abnormality state was released in the flow chart illustrated in FIG. 8. Here, the MFP control unit 113 executes the display process so as to maintain the display state of the device even after the device abnormality state was released (FIG. 8), according to the program stored in the program storage unit 116. In FIG. 13, the message “COPY/A4 GREEN” indicates the state that there is no abnormality. FIG. 14 is a diagram illustrating an example of displaying the operation buttons for the device and the operation buttons for the input image data 105 on the operation input unit 102. More specifically, FIG. 14 indicates an example of the arrangement of the objects produced in the process flow illustrated in FIG. 6. In FIG. 14, also the operation buttons for the moving image data and the voice data displayed on the image display area are set to the priority display objects (the buttons or the display items) set on the display priority order table 114. More specifically, the “−CH+” button is the button for selecting a channel to be used for digital terrestrial television broadcasting, cable broadcasting or the like. The “−VOL+” button is the button for selecting a volume level of the voice data output based on the moving image data. Under the control of the MFP control unit 113, the operation objects (the “COPY” button, the “FAX” button, and the like) concerning the device and the operation objects (the “−CH+” button, the “−VOL+” button, and the like) concerning the input image data 105 are together displayed. Consequently, it brings a significant advantage that, even if the user is executing the operation concerning viewing of the received image, he/she can use the device functions such as the “COPY” function, the “FAX” function, the “SEND” function and the like without changing over the operation screen. FIG. 15 is a diagram illustrating an example of executing priority display based on the attributes of the display objects (the buttons or the display items) on the operation unit. More specifically, FIG. 15 indicates an example of the operation in a case where the display setting of the objects (the buttons or the display items) displayed on the operation input unit 102 has been set to the attribute priority of the display objects (FIG. 9). In this case, the objects (the buttons of the display items) concerning the voice data and the image data have priority over the objects concerning the device (“COPY”, “FAX”, “SEND”, and the like).

In FIG. 15, a state 1500 indicates that the MFP control unit 113 does not receive image data. That is, the state 1500 is equivalent to an ordinary standby state of the device.

A state 1501 indicates that the object (the playback/pause button) concerning the image display area 202 is added as the essential display object. As described above, the objects (the buttons or the display items) which should be non-displayed if the received image data 105 is displayed on the operation input unit 102 is defined in the present embodiment. However, the present invention is not limited to this. That is, the relevant objects may be defined as “reduction displayed objects” instead of “non-displayed objects”. In this case, the relevant displayed objects are reduced in size and then rearranged so as not to block out the image display area 202, the essential display objects and the priority display objects. To achieve this, concretely, in regard to the flow charts illustrated in FIGS. 4 to 9, it only has to replace the portions concerning the processes for executing non-display to the objects with the processes for executing reduction display. In this case, the MFP control unit 113 only has to execute the above processes according to the program stored in the program storage unit 116. In addition, the input operation unit 102 may include a processor, a program storage unit and the like, and thus execute the above processes.

In any case, although it is not illustrated specifically, also information (e.g., version information, creator information, etc.) for administrating the program groups stored in the storage medium may occasionally be stored in the storage medium, and information (e.g., icon information for discriminatively displaying a program, etc.) depending on an OS or the like on the program reading side may occasionally be stored in the storage medium.

Moreover, the data depending on the various programs are administrated on the directory of the storage medium. Besides, a program to install various programs into a computer, a program to uncompress or extract installed programs and data when the installed programs and data have been compressed, and the like are occasionally stored.

Furthermore, the functions of the present embodiment may be executed by a host computer based on externally installed programs. In that case, the present invention is applicable even in a case where an information group including the programs is supplied from a storage medium (such as a CD-ROM, a flash memory, an FD or the like) or an external storage medium through a network to an output apparatus.

As described above, the object of the present invention can be achieved in a case where the storage medium, on which the program code of software for achieving the functions of the present embodiment, is supplied to the apparatus.

In this case, the computer (or CPU or MPU) of the apparatus reads and executes the program codes stored in the supplied storage medium.

In this case, since the program codes themselves read from the storage medium achieve the new functions of the present invention, the storage medium storing these program codes constitutes the present invention.

As the storage medium for supplying the program codes, for example, a flexible disk, a hard disk, an optical disk, a magnetooptical disk, a CR-ROM, a CD-R, a CD-RW, a DVD-ROM, a magnetic tape, a nonvolatile memory card, a ROM, an EEPROM, a silicon disk or the like can be used.

Moreover, it is needless to say that the present invention includes not only a case where the functions of the above embodiment are achieved by executing the program codes read by the computer, but also a case where an OS (operating system) or the like functioning on the computer executes a part or all of the actual process according to instructions of the program codes, whereby the functions of the above embodiment are achieved by that process.

Moreover, it is needless to say that the present invention includes a case where the functions of the above embodiment can be achieved if the program codes read from the storage medium are once written in a memory provided on a function expansion board inserted in the computer or a function expansion unit connected to the computer, and then the CPU or the like provided in the function expansion board or the function expansion unit executes a part or all of the actual process according to the instructions of the program codes.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-162494, filed Jun. 20, 2007 which is hereby incorporated by reference herein in its entirety.

What is claimed is:

1. An image displaying apparatus which displays plural display objects on a display unit, comprising:
a determining unit configured to determine priority for each of the plural display objects, the priority having plural levels; and
a display control unit configured to change displays of the plural display objects in the priority determined by the determining unit, in accordance with a display form of an image different from the plural display objects.

2. An image displaying apparatus according to claim 1, wherein the display control unit displays the plural display objects in the priority determined by the determining unit so that a display area of the image does not overlap the display objects, in accordance with the display form of the image different from the plural display objects.

3. An image displaying apparatus according to claim 1, wherein, in a case where a display area of the image displayed on the display unit is enlarged, the display control unit changes the display of the display object displayed on the display unit so that the display object does not overlap the enlarged display area of the image, in the priority determined by the determining unit.

4. An image displaying apparatus according to claim 1, wherein the plural display objects include a display object for executing an operation concerning the image displaying apparatus and a display object for executing an operation concerning the image.

5. An image displaying apparatus according to claim 1, wherein the display object is a display screen indicating a state of the image displaying apparatus.

6. An image displaying apparatus according to claim 1, wherein the display area of the image is determined based on an aspect ratio of the image to be displayed on the display unit.

7. An image displaying apparatus according to claim 1, wherein
the image displaying apparatus can execute at least one of a copy function and a print function, and
the display object is an operation key for executing an operation concerning at least one of the copy function and the print function.

8. An image displaying method which displays plural display objects on a display unit, comprising:
determining priority for each of the plural display objects, the priority having plural levels; and
changing displays of the plural display objects in the determined priority, in accordance with a display form of an image different from the plural display objects.

9. An image displaying method according to claim 8, wherein, in a case where the image different from the plural display objects is displayed on a display unit, the plural display objects are displayed in the determined priority so that a display area of the image does not overlap the display objects.

10. An image displaying method according to claim 8, wherein, in a case where a display area of the image displayed on a display unit is enlarged, the display object displayed on the display unit is displayed in the determined priority so that the display object does not overlap the enlarged display area of the image.

11. An image displaying method according to claim 8, wherein the plural display objects include a display object for executing an operation concerning an image displaying apparatus and a display object for executing an operation concerning the image.

12. An image displaying method according to claim 8, wherein the display object is a display screen indicating a state of an image displaying apparatus.

13. An image displaying method according to claim 8, wherein a display area of the image is determined based on an aspect ratio of the image to be displayed on a display unit.

14. An image displaying method according to claim 8, wherein
the image displaying method is a method which is used in an image displaying apparatus,
the image displaying apparatus can execute at least one of a copy function and a print function, and
the display object is an operation key for executing an operation concerning at least one of the copy function and the print function.

15. A recording medium readable by a computer and storing a computer-executable program for displaying plural display objects on a display unit, the computer-executable program comprising:
a code to determine priority for each of the plural display objects, the priority having plural levels; and
a code to execute control to display the plural display objects in the determined priority, in accordance with a display form of an image different from the plural display objects.

16. A computer-executable program for displaying plural display objects on a display unit, the computer-executable program comprising:
a code to determine priority for each of the plural display objects, the priority having plural levels; and
a code to execute control to display the plural display objects in the determined priority, in accordance with a display form of an image different from the plural display objects.
